(19) United States
(12) Patent Application Publication
(10) Pub. No.: US 2007/0056360 A1
(43) Pub. Date: Mar. 15, 2007

(54) Method and apparatus for sampling a fluid

(75) Inventors: Richard Alexander Grant, St. Kilda (AU); Warren James Hancock, Middle Park (AU)

Correspondence Address: BANNER & WITCOFF, 1001 G STREET N W, SUITE 1100, WASHINGTON, DC, 20001, US

(73) Assignee: Invetech Pty Ltd, Mount Waverley (AU)

(21) Appl. No.: 10/562,397

(22) PCT Filed: Jun. 25, 2004
(86) PCT No.: PCT/AU04/00838

§ 371 Date: Jun. 9, 2006

(30) Foreign Application Priority Data
Jun. 27, 2003 (AU) 2003903254

(51) Int. Cl. G01N 1/00

(52) U.S. Cl. 73/64.56

(57) ABSTRACT

A fluid sampling probe may be provided in a unitary assembly for aspirating fluid samples by way of a reduced diameter piercing portion in direct fluid communication with a reservoir for (temporarily) storing and/or transporting a sample, including: a first portion for piercing a closed fluid carrier, a second portion serving as a reservoir for receiving a fluid, the second portion being formed integrally operative with the first portion and a third portion providing fluid communication between the first and second portion. The fluid sampling probe 20 may be used to provide a high throughput aliquotting system for handling precise quantities of material. Accordingly, the division of a sample of a substance into parts (equal or otherwise), each of which representing a known quantitative relationship to each other and to the sample as a whole is enabled on a large scale.

### RELATED APPLICATIONS

This application claims priority to Australian Provisional Patent Application No. 2003903254, filed 27 Jun. 2003 by the present applicant and entitled “Method and Apparatus for Sampling a Fluid” and, the specification thereof is incorporated herein by reference in its entirety and for all purposes.

### FIELD OF INVENTION

The present invention relates to the field of fluid sampling, including a method, apparatus and/or system therefor, for example, the invention relates to aspirating fluid samples from closed containers. In one form, the invention relates to a method and apparatus for aspirating fluid samples from Vacutainers™ or vials containing biological fluid, and it will be convenient to hereinafter describe the invention in relation to that application. It should be appreciated, however, that the present invention is not limited to that application, only. In one particular aspect, the present invention is also suitable for use in providing an automated method and device for aspirating fluid samples from a plurality of containers.

### BACKGROUND OF INVENTION

Throughout this specification the use of the word “inventor” in singular form may be taken as reference to one (singular) or all (plural) inventors of the present invention. The inventor has identified the following related art. Diagnostic samples, for example, blood, urine, sputum, faeces, etc are often enclosed in tubes closed, or more often, sealed with rubber bungs (or caps, etc). In environments such as modern clinical laboratories, samples may be processed in an instrument, which may often be automated for greater throughput of samples, with the aim of processing without contaminating the user of the instrument or subsequent samples. Removing a sample from a tube without contaminating the user or subsequent samples is required for safe, consistent testing and investigation of results. Piercing the bung, or cap, has many problems associated with it in the related art. Manually, or otherwise removing caps prior to insertion into the instrument exposes the user to contamination by the sample, and further exposes the environment and the sample to contamination, as well as allowing evaporation of the sample to occur which may distort the accuracy of the ‘true’ sample reading.

U.S. Pat. No 6,324,926 (Lehtinen et al) discloses a method and device for taking a sample from a closed test tube, which as described by Lehtinen is a vacuum specimen tube. The object of Lehtinen is to take a sample from the vacuum tube without removing a stopper sealing the tube by piercing the stopper with a needle, through which at least part of the sample is taken from the tube. The disclosed sampling device is complex and includes an adapting element for fitting the test tube with, a piercing needle first to a separate sampling device, a cup-like sample receptacle and a suction device fitted in connection to the receptacle for drawing sample from the test tube into the sample receptacle. The method of Lehtinen involves piercing the rubber bung or stopper of a test tube with a single needle which passes through and accesses the fluid in the tube, however, all it then does is provide a path to the sample receptacle, which is a cavity formed by the other components of the disclosed sampling device. The other components allow for drawing fluid through the single needle and dripping it into the sample receptacle, which is then capable of, for example, being washed and purged to waste. The suction device may only be applied to the sample once it has been placed in the sample receptacle. A pipetting needle or device, separate to the piercing needle, is required if the sample is to be transferred to other stations for further processing.

U.S. Pat. No. 6,010,463 (Lauks et al) discloses a device and method for collecting a fluid sample and introducing it into a sensing device for real time analysis. This device is intended to sample blood directly from a patient or a closed tube with the intent of coupling or passing the blood directly to a disposable sensing device (i-stat). Lauks discloses a device adapted for use with a conventional Vacutainer™-type blood collection system. These conventional blood collection systems consists of a housing, a first needle cannular adapted for insertion into a patient and a second needle cannular at the opposite end of the housing adapted for penetration into an evacuated container for collection of the blood sample. A device of Lauks, in one embodiment thereof, consists of a reservoir adapted for connection to the conventional sampling system via a resealable penetrable stopper. At the other end thereof is a puncturable seal fixed on an inside ledge of a closure cap leading to a capillary tube fitted in a capillary tube holder that penetrates the puncturable seal thereby allowing sampled blood to flow into the capillary tube. Lauks is a complex device which is directed to a manual system for taking small samples of blood and applying these samples to a small disposable test cartridge. Lauks does not address the problems associated with efficient and high volume handling of fluid samples in an automated system.

Any discussion of documents, devices, acts or knowledge in this specification is included to explain the context of the invention. It should not be taken as an admission that any of the material formed part of the prior art base or the common general knowledge in the relevant art in Australia or, the United States on or before the priority date of the claims herein.

### SUMMARY OF INVENTION

In one aspect the present invention provides a fluid sampling probe for aspirating fluid samples comprising: a first portion for piercing a closed fluid carrier, a second portion serving as a reservoir for receiving a fluid, the second portion being formed integrally operative with the first portion and a third portion providing fluid communication between the first and second portion.

In essence, the present invention stems from providing a probe with a combination of a reduced diameter piercing portion in direct fluid communication with a reservoir for (temporarily) storing a sample. The present invention may be provided by combining these functions in a unitary assembly rather than separate components.

Preferably, the second portion comprises a disposable moulded reservoir having a capacity sufficient for containing a sample volume of fluid. It is also preferable that the first portion comprises the piercing head of a relatively small diameter hypodermic needle. The needle gauge of the hypodermic needle is preferably in the range of 12-20 AWG and may come in a range of lengths. In this embodiment, the third portion comprises the shaft of the hypodermic needle. The disposable reservoir may be joined to the third portion by UV activated adhesive such that the probe forms a disposable combination for single use. Preferably, the second portion comprises a disposable moulded reservoir of one of a plurality of sizes and shapes to accommodate a range of sample volumes.

In another embodiment, the first portion may be moveable with respect to the second portion such that, upon disengaging with the second portion, a fluid flow path from the carrier to the second portion is formed between a distal end of the second portion and the first portion.

In a preferred form, the first portion comprises the head of a trocar needle. The trocar needle head may be sealingly engageable with the second portion such that the probe presents to a closed carrier as an integral sealed piercing element. The trocar needle head may be moveable with respect to the second portion such that, upon disengaging with the second portion, a fluid flow path from the carrier to the second portion is formed between a distal end of the second portion and the piercing head of the trocar needle. Preferably, the trocar needle head movement is axial with respect to the second portion. Alternatively, the second portion may be movable axially with respect to the trocar needle head.

The second portion may comprise a cannular needle for accommodating a relatively small diameter shaft of the trocar needle therewithin such that the second portion is defined by a wall of the cannular needle acting as an outer envelope for the received fluid. The second portion may comprise a hollowed vessel. The probe itself may be disposable or a reusable and washable part of an instrument.

In another aspect, the present invention provides an automated fluid sampling system comprising: a handling mechanism for conveying a plurality of closed fluid carriers; a fluid sampling station for receiving and locating the fluid carriers conveyed by the handling mechanism wherein, the system is adapted to operatively accommodate a fluid sampling probe as described.

The system may further comprise dispensing means for dispensing the sample volume of fluid from the sampling probe via the first portion. In this particular embodiment, the trocar needle, comprising a head and a shaft, may be of a larger diameter and the shaft itself may be hollow for enclosing the sample volume within. It has been found that this embodiment provides advantageous fluid control on dispensing the sample fluid from the probe assembly. Alternatively, the sample volume of fluid may be transferred from the second portion internally through the system for further processing and analysis.

In a further aspect the present invention provides a method of sampling a fluid from a closed fluid carrier using a probe as described, the method comprising the steps of: (a) piercing the closed fluid carrier with a portion of the probe; (b) advancing a first portion of the probe into contact with the fluid of the carrier; (c) forming a fluid flow path between the fluid of the carrier and a second and/or third portion of the probe; (d) aspirating a sample volume of the fluid along the fluid flow path; (e) retaining the sample volume of fluid within the second and/or third portion of the probe upon withdrawal of the probe from the carrier. In one embodiment, for example, a trocar needle may be used for step (e).

The method may further comprise the step of: (f) using the probe to dispense the sample as required. For example, the method may further comprise the step of dispensing the sample volume of fluid from the second portion via the first portion. Alternatively, the method may further comprise the step of transferring the sample volume of fluid from the second and/or third portion of the probe via a point remote from the first portion.

The method may further comprise the step of: (g) disposing of the fluid sampling probe. In a preferred form, the method further comprises the steps of: (h) exchanging the disposed probe with one of a plurality of probes having a range of second portion sizes and/or shapes and; (i) repeating steps (a) to (g).

In one embodiment, step (c) may comprise the step of axially extending the first portion of the probe from sealed engagement with the second portion to form the fluid flow path. Further, step (e) may comprise the step of axially retracting the first portion to sealingly engage the second portion prior to withdrawal of the probe from the carrier.

In another aspect the present invention provides a method of integrally combining a first and second portion of a sampling probe as described, the method comprising the step of: synthesizing the first and second portions together. This may be by an adhesive joint, preferably made with a UV stabilised adhesive. Alternatively, the method may comprise the step of: synthesizing the first and second portions together as a one piece integrally moulded part. The method of integrally combining the first and second portions may further comprise the step of: integrating a third portion intermediate the first and second portions. The third portion may be integrated by adhesively joining, preferably with a UV stabilised adhesive, the shaft of a hypodermic needle to the base portion of a moulded reservoir. Alternatively, the third portion may be integrated by forming a fluid flow channel between the second portion and an external aperture adjacent the first portion.

The present invention also provides apparatus for sampling fluid from a closed fluid carrier, the apparatus being adapted to operate in accordance with the method as described.

Other aspects and preferred forms of the invention are disclosed in the following specification and/or defined in the appended claims, forming a part of the description of the invention.

In accordance with embodiments of the present invention, a reservoir integral to the piercing needle provides advantages over complex related art mechanisms, which do not facilitate a sample volume carrying portion. Embodiments of the present invention enable a fluid sampling system to hold a volume of fluid with the envelope of a disposable piercing tip. It is desirable, with this functionality at hand, to be able to pick up disposable tips in the form of probes according to embodiments of the invention, pierce and aspirate from closed containers and carry the sampled fluid around dispensing possibly to a number of locations, within a laboratory or laboratory instrument for example, from the sample fluid reservoir. There are a number of applications for the present invention in industry. One example, without being a limiting example, is the enablement by use of the invention of a high throughput aliquotting system for handling precise quantities of material. Accordingly, the division of a sample of a substance into equal parts, each of which representing a known quantitative relationship to each other and to the sample as a whole is enabled on a large scale.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, improvements, aspects, features and advantages of one or more preferred embodiments of the present invention will be readily apparent to one of ordinary skill in the art from the following written description with reference to and, used in conjunction with, the accompanying drawings, which are provided by way of illustration only, and thus are not limiting to the scope of the present invention, and in which:

FIG. 1 is a perspective side view of a fluid sampling probe in accordance with a first embodiment of the present invention;

FIG. 2a is a perspective side view of a fluid sampling probe in accordance with a second embodiment of the present invention.

FIG. 2b is a sectional side view of the fluid sampling probe of FIG. 2a.

FIG. 3a is a sectional side view of a probe assembly according to a third embodiment of the present invention, in which the probe assembly may comprise a portion of an automated fluid sampling system, and wherein the probe assembly is in a first position prior to piercing a closed fluid carrier.

FIG. 3b is a sectional side view of the probe assembly shown in FIG. 3a showing the fluid sampling probe in a second position prior to making fluid contact with a fluid volume within a closed fluid carrier.

FIG. 4a is a sectional side view of a probe assembly according to a fourth embodiment and in which the probe assembly may also comprise a portion of an automated fluid sampling system.

FIG. 4b is sectional side view of the probe assembly as shown in FIG. 4a, where the assembly is in a position prior to making fluid contact with a fluid volume within a closed fluid carrier and, in which position the probe assembly may also be used for dispensing a sample for use within an automated instrument.

FIG. 5a is a perspective view of part of an automated fluid sampling system or instrument comprising a probe assembly as shown in any of FIGS. 3 or 4 wherein, the probe assembly is in a first position prior to piercing a closed fluid carrier.

FIG. 5b is a perspective view of part of an automated fluid sampling system or instrument comprising a probe assembly as shown in any of FIGS. 3 or 4 wherein, the probe assembly is in a second position prior to making fluid contact with a fluid volume within a closed fluid carrier.

FIG. 6 is a perspective side view of an alternate mechanical arrangement of a fluid sampling probe in accordance with a first embodiment of the present invention.

### DESCRIPTION OF PREFERRED EMBODIMENT

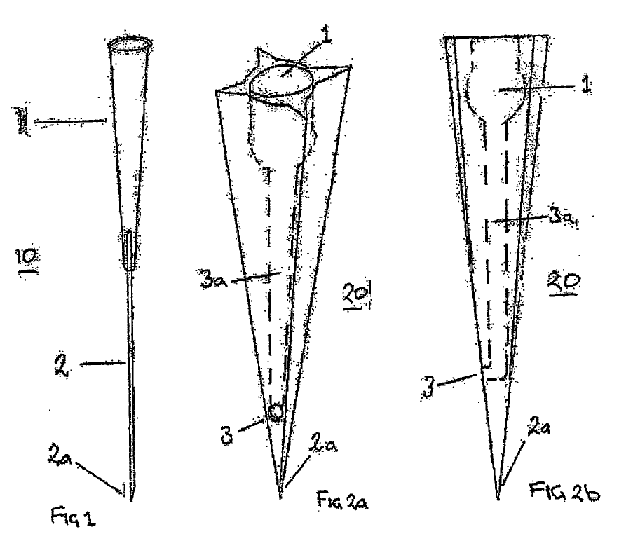

FIG. 1 shows a first embodiment of a fluid sampling probe 10 comprising a moulded fluid receiving region in the form of a reservoir 1. The probe 10 may be in the form of a range of reservoirs of different volumes with a hypodermic needle 2 attached to the reservoir 1. The fluid reservoir 1 may accommodate a volume of fluid and the needle head 2a may penetrate a bung/cap of a closed fluid carrier (not shown) to the depth required. The preferred form of fluid carrier for which the present invention has application may be a Vacutainer™, a common form of vial for containing biological fluid. The small diameter needle head 2a requires minimal force to pierce the bung/cap. The assembly 10 is disposable for dedicated use on each sample contained in a fluid carrier. Generally, the assembly 10 incorporates a metal needle 2 for piercing and a moulded reservoir 1 to contain the sample volume. The fluid sampling probe 10 is typically attached to a fluid sampling system by pressing the fluid sampling probe 10 on to a tapered fitting to affect a mechanical and air tight seal for aspirating and dispensing fluids. When the fluid manipulation is complete the fluid sampling probe 10 may then be mechanically stripped of the tapered fitting of the fluid sampling system. Other means of attachment of fluid sampling probes 10 to a fluid sampling system may alternatively be envisaged by those skilled in the art.

The joining of a moulded fluid reservoir 1 to a small diameter piercing needle head 2a is preferably accomplished by adhering the needle 2 to the reservoir 1 with UV light cured adhesive thus providing the strength to pierce and aspirate from closed tubes. In contrast, it has been found that plastic welding or overmoulding may suffer from gaps caused by shrinkage due to differing thermal expansion rates. A range of sample volumes may be aspirated with different size reservoirs 1. As a combination the assembly 10 provides:
Reliable easy piercing.
Less susceptible to plugging flow path within needle 2 or tubes
Low force required to pierce by virtue of the smaller area of needle head 2a contacting the cover of a fluid carrier.
Disposable tips 10 mean no sample-to-sample carryover.
No need to wash tips 10 which, reduces fluid waste produced by instruments.

The combination of the embodiment of FIG. 1 minimises reliability issues, as it is less likely to clog the fluid path as a one piece needle 2 and tip 10. Reservoirs 1 may be manufactured in a range of volumes for different sample requirements.

An underlying advantage of the embodiment of FIG. 1 is that it minimises needle 2 diameter and therefore the force required to pierce a closed container cap, combined with the ability to aspirate a volume of sample for processing and then other subsequent samples without carryover of one sample to another. Providing a fluid reservoir 1 in a range of sizes allows the sampling tip 10 of FIG. 1 to aspirate a given variety of sample volumes without the need for contacting permanent fluid lines.

The small diameter needle 2 may be provided in a range of lengths and diameters to suit a variety of sampling requirements. These could be a range of different sample volumes (i.e. 5-1,000 microlitres or more) and the range of volumes could require larger diameter and larger lengths of hypodermic needles 2 in order to aspirate the fluid at a specific rate and access the sample fluid at different depths in a range of sample vial geometries. The relatively small diameter of the hypodermic needle head 2a necessitates low piercing force. As the tip may be disposable, as such it may be dedicated to one sample.

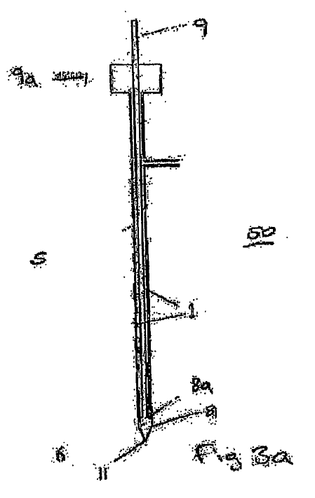

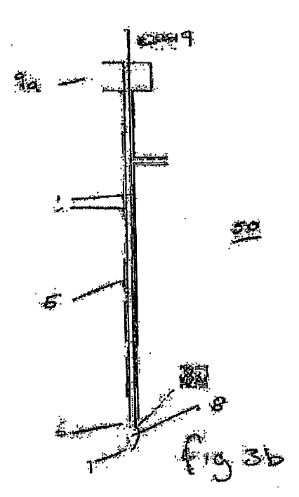

A variation of the single use disposable sampling tip that embodies the inventive concept is the one piece moulded tip 20 of FIGS. 2a and 2b which can pierce and hold sample volume. Like reference numerals have been used in FIGS. 2a and 2b to indicate the features already described with reference to FIG. 1.

A disposable aspirating/dispensing tip 20 capable of piercing closed sample tubes as shown in FIGS. 2a and 2b includes a fluid receiving region 1 and a pointed sharpened piercing extremity 2a. An aperture 3 located on the periphery of the piercing extremity 2a provides fluid communication for a channel 3a forming a fluid flow path between the fluid carrier and the fluid receiving region 1.

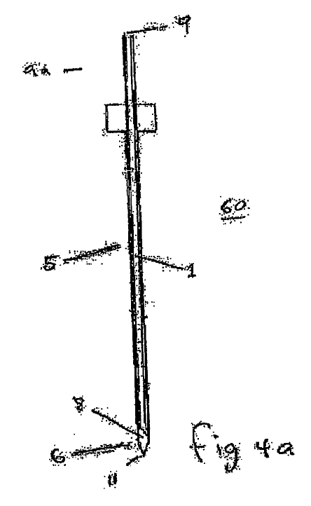

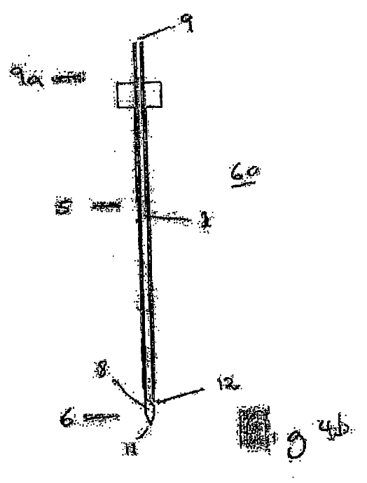

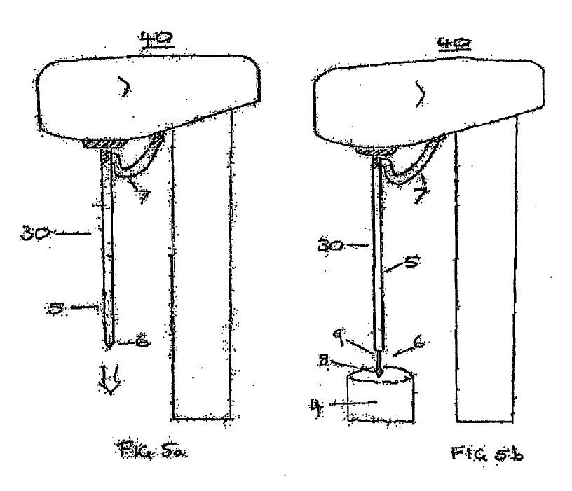

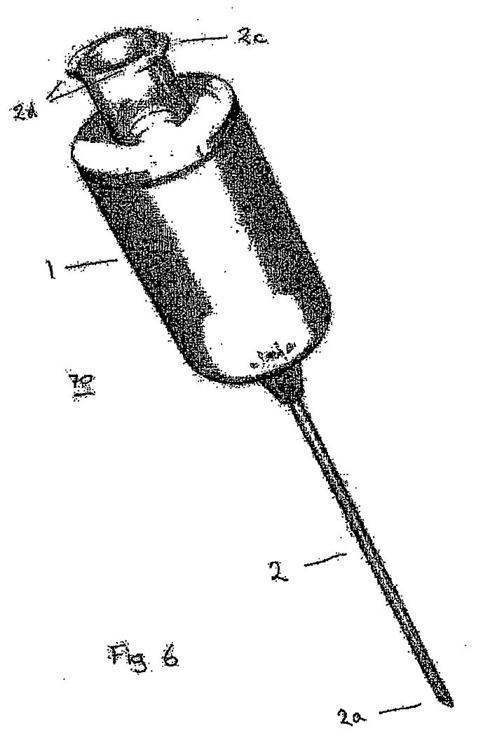

In preferred embodiments of the probe assembly for aspirating fluid samples from closed containers, namely, tubes, Vacutainers or vials, a washable piercing aspirating probe is shown in detail in FIGS. 3a, 3b, 4a and 4b and generally shown as part of a fluid sampling system 40 in FIGS. 5a and 5b.

As shown in FIG. 3a, a two piece probe 50 is provided comprising an outer cannular 5 and an inner trocar style needle 6 for piercing a bung. When the probe tip 8 has passed through the bung, the trocar needle 6 is advanced to the position shown in FIG. 3b to create a fluid path from the tip 8 of the probe 30 to a reservoir 1 defined by the walls of an outer cannular 5. Initially, venting to atmosphere may equalise any residual pressure or vacuum then the probe 50 is advanced to below the liquid level enabling the aspiration of the sample. The trocar needle 6 is retracted to seat, and preferably seal, against the outer cannular 5 and is removed from the sample container. The fluid sample may then be dispensed out through the trocar probe 30 disposed in the position shown in FIG. 3b, or in a further embodiment of the invention, plumbed directly through in the direction of distal needle tip 9a to be processed elsewhere in the instrument 40.

According to the embodiment of FIGS. 3a and 3b, an inner trocar needle 6 has a relatively small diameter shaft 9 with a larger diameter head 8. This larger diameter head 8 features a sharp piercing point 11 and a sealing surface 8a on the rear which can form a seal with the end of the outer cannular needle 5. The trocar needle 6 may be automatically advanced and retracted to allow the probe 30 to perform its functions.

The outer cannular needle 5 provides the structural strength required to support the trocar needle 6 enabling it to pierce a bung of a fluid carrier and also provides the envelope for the fluid reservoir 1 or cavity to retain the aspirated fluid. The probe 50 may be plumbed to a fluidics system 7 of the instrument 40 shown in FIGS. 5a and 5b, allowing the venting to atmosphere as well as the aspiration and associated handling of the fluid samples.

The two piece approach of the embodiments of FIGS. 3 and 4, gives a probe 50, 60 which can present to the bung of a carrier as a one piece piercing probe 50, 60 by virtue of the trocar needle 6 and the cannular 5 forming one outer surface when the trocar needle 6 is sealed against the cannular 5. This prevents plugging the fluid path with cored samples or chips of rubber. The two piece approach then gives a probe 50, 60 that may automatically adapt itself into a probe 50, 60 with an in built fluid path for liquid handling.

The movable trocar needle 6 provides the piercing point and the seal to the outer cannular needle 5. The outer cannular needle 5 provides the structural strength to perform the piercing action and forms the boundary of the fluid envelope or reservoir 1.

The axial motion of the trocar needle head 8 with respect to the cannular needle 5 provides the ability to have the probe 50, 60 act as a piercing probe without an open fluid path susceptible to clogging or blocking and to convert the probe 50, 60 into a fluidics probe capable of aspiration and dispensing. Advantages of these embodiments include:
Reliable easy piercing.
Less susceptible to plugged probes
Won't core bungs
Washable probe
Stronger piercing probes

Adapted as a sampling probe for a system as partly shown in FIGS. 5a and 5b, the invention provides a solution for automated piercing and sampling of sealed sample containers. The diameter of the cannular needle 5 may be chosen to provide increased structural strength.

The embodiment of the probes 50, 60 in FIGS. 3 and 4 as adapted to operate in an automated instrument 40 as partly shown in FIGS. 5a and 5b, allows for piercing closed sample tubes on the automated instrument 40 and for processing the sample within the instrument 40. The system 40 may be capable of fluid handling by aspirate/dispense and also aspirating a sample volume and transporting it throughout the instrument 40. The probe diameter may be minimised to reduce the piercing force required but still allow sufficient room for fluid transport. The susceptibility to coring the bung and plugging/blocking the fluid path may be overcome.

The embodiments of probes 50, 60 in FIGS. 3a, 3b, 4a and 4b allows axial movement of trocar needle 6 or, in another embodiment axial movement of the cannular needle 5 with respect to the trocar needle 6. These embodiments also allow conversion of the probe 50, 60 from piercing probe to aspirating probe and vice versa.

With reference to FIGS. 4a and 4b, a trocar needle 6 is used, having a large diameter 9 and of a hollow section providing for fluid carrying capacity as a reservoir 1. In this embodiment the cannular needle 5 protects a side hole or aperture 12 (as shown in FIG. 4b) connecting the reservoir 1 to piercing point 11 for fluid flow, from plugging on piercing the bung and then cannula 5 moves to expose the side hole 12 which can then be vented to equalise pressure before aspirating the sample from a closed fluid carrier. The trocar needle 6 is extended from it's position shown in FIG. 4a into the position as shown in FIG. 4b for aspiration. It has been found that accurate dispensing of fluid may be achieved by use of the larger diameter trocar needle 6 releasing retained sample fluid from within its reservoir 1.

FIG. 6 shows an alternate mechanical arrangement to the first embodiment of the present invention of a fluid sampling probe. The alternate sampling probe 70 similar to that shown in FIG. 1 comprises a moulded fluid receiving region in the form of a reservoir 1. The probe 70 may be in the form of a range of reservoirs of different volumes with a hypodermic needle 2 attached to the reservoir 1. The fluid reservoir 1 may accommodate a volume of fluid and the needle head 2a may penetrate a bung/cap of a closed fluid carrier (not shown) to the depth required. Again the preferred form of fluid carrier for which this embodiment of probe 70 has application may be a Vacutainer™. The small diameter needle head 2a requires minimal force to pierce the bung/cap. The assembly 70 may be disposable for dedicated use on each sample contained in a fluid carrier. Generally, the assembly 70 incorporates a metal needle 2 for piercing and a moulded reservoir 1 to contain the sample volume. In this alternate arrangement or additional feature of the probe, a Luer type fitting 2c shown integrally moulded at the end of the reservoir portion 1 is a preferred means to make a secure mechanical connection between the fluid sampling probe 70 and a fluid sampling system. The preferred Luer connection 2c provides a screw type mechanical attachment and seal by a twisting and engaging motion facilitated by the flanges 2d of the fitting. Other methods of attachment could be envisaged by those skilled in the art such as a bayonet fitting or a cam interlock mechanism. Furthermore, the Luer fitting and means of attachment and connection of the probe to a fluid sampling system may be applied to a sampling probe as described in relation to the one piece moulded tip according to the second embodiment as shown in FIGS. 2a and 2b. For example, the Luer fitting may be integrally moulded (not shown) in the probe of FIG. 2a or 2b at the end, which accommodates the fluid receiving region 1.

Whilst the embodiments of the present invention facilitate and enable high throughput handling of fluids on a large scale, it will be understood by the person skilled in the art that these respective embodiments lend themselves to automated operation by way of apparatus comprising (digital or computer) processor means, ordinarily in the form of microprocessor device(s), operating in accordance with a predetermined instruction set and, in conjunction with said instruction set, being adapted to perform the methods of operation as disclosed herein, whether that be the handling of fluid samples/sampling or, the synthesis of probes in accordance with embodiments of the present invention.

In embodiments of the present invention there is provided a computer program product comprising:

a computer usable medium having computer readable program code and computer readable system code embodied on said medium for sampling a fluid from a closed fluid carrier within a data processing system, said computer program product comprising:

computer readable code within said computer usable medium for performing the method of sampling a fluid from a closed fluid carrier using a probe as disclosed herein.

Furthermore, in embodiments of the present invention there is provided a computer program product comprising:

a computer usable medium having computer readable program code and computer readable system code embodied on said medium for integrally combining a first and second portion of a probe within a data processing system, said computer program product comprising:

computer readable code within said computer usable medium for performing the method of combining a first and second portion of a probe as disclosed herein.

While this invention has been described in connection with specific embodiments thereof, it will be understood that it is capable of further modification(s). This application is intended to cover any variations uses or adaptations of the invention following in general, the principles of the invention and comprising such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the present invention as defined in the appended claims. Various modifications and equivalent arrangements are intended to be included within the spirit and scope of the present invention and appended claims. For example, with respect to the embodiment of FIGS. 3a and 3b, as a two piece probe 30 capable of piercing and aspirating from closed sample tubes on an automated instrument 40, the probe 30 is also capable of dispensing the sample into a target vessel or carrier for further processing and analysis.

Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1. A fluid sampling probe for aspirating fluid samples comprising:
a first portion for piercing a closed fluid carrier,
a second portion serving as a reservoir for receiving a fluid, the second portion being formed integrally operative with the first portion for piercing the closed fluid carrier, and
a third portion providing fluid communication between the first and second portion.

2. A probe as claimed in claim 1, wherein the second portion comprises a disposable molded reservoir having a capacity sufficient for containing at least one sample volume of fluid.

3. A probe as claimed in claim 1, wherein the first portion comprises the piercing head of a relatively small diameter hypodermic needle.

4. A probe as claimed in claim 3, wherein the needle gauge of the hypodermic needle is in the range of 12-20 AWG.

5. A probe as claimed in claim 2, wherein the disposable reservoir is joined to the first portion by a UV cured adhesive joint such that the probe forms a disposable combination for single use.

6. A probe as claimed in claim 3, wherein the second portion comprises a disposable molded reservoir of one of a plurality of sizes to accommodate a range of sample volumes.

7. A probe as claimed in claim 1, wherein the first portion is moveable with respect to the second portion such that, upon disengaging with the second portion, a fluid flow path from the carrier to the second portion is formed between a distal end of the second portion and the head of the first portion.

8. A probe as claimed in claim 7, wherein the first portion comprises the head of a trocar needle.

9. A probe as claimed in claim 8, wherein the second portion comprises a cannular needle for accommodating a relatively small diameter shaft of the trocar needle therewithin such that the second portion is defined by a wall of the cannular needle acting as an outer envelope for the received fluid.

10. A probe as claimed in claim 9, wherein the second portion is a hollowed vessel.

11. A probe as claimed in claim 1, wherein the probe is disposable.

12. An automated fluid sampling system comprising:
a handling mechanism for conveying a plurality of closed fluid carriers;
a fluid sampling station for receiving and locating the fluid carriers conveyed by the handling mechanism, and wherein the system is adapted to operatively accommodate at least one fluid sampling probe including
a first portion for piercing a closed fluid carrier,
a second portion serving as a reservoir for receiving a fluid, the second portion being formed integrally operative with the first portion for piercing the closed fluid carrier, and
a third portion providing fluid communication between the first and second portion.

13. A probe as claimed in claim 12, wherein the second portion is adapted at one end thereof to form a mechanical connection between the fluid sampling probe and the fluid sampling.

14. A probe as claimed in claim 13 wherein the second portion comprises a Luer fitting for forming the mechanical connection between the fluid sampling probe and the fluid sampling system.

15. A method of sampling a fluid from a closed fluid carrier using a probe including a first portion for piercing a closed fluid carrier, a second portion serving as a reservoir for receiving a fluid, the second portion being formed integrally operative with the first portion for piercing the closed fluid carrier, and a third portion providing fluid communication between the first and second portion, the method comprising the steps of:
(a) piercing the closed fluid carrier with a portion of the probe;
(b) advancing the first portion of the probe into contact with the fluid of the carrier;
(c) forming a fluid flow path between the fluid of the carrier and the second portion of the probe;
(d) aspirating a volume of the fluid along the fluid flow path;
(e) retaining the volume of fluid within the second portion of the probe upon withdrawal of the probe from the carrier.

16. A method as claimed in claim 15, wherein a trocar needle is used for step (e).

17. A method as claimed in claim 15, further comprising the step of:
(f) using the probe to dispense at least one sample of fluid as required.

18. A method as claimed in claim 15, further comprising the step of:
(g) disposing of the fluid sampling probe.

19. A method as claimed in claim 18, further comprising the step of:
(h) exchanging the disposed probe with one of a plurality of probes having a range of second portion sizes and/or shapes, and;
(i) repeating steps (a) to (g).

20. A method as claimed in claim 15 wherein, step (c) further comprises the step of axially extending the first portion from sealed engagement with the second portion to form the fluid flow path.

21. A method as claimed in claim 20 wherein, step (e) further comprises the step of axially retracting the first portion to sealingly engage the second portion prior to withdrawal of the probe from the carrier.

22-30. (canceled)

31. A system as claimed in claim 12 wherein the sampling probe comprises a trocar needle having a head and a shaft, the shaft being hollow for enclosing at least one sample volume within and for dispensing the at least one sample as required.

32-33. (canceled)
